(19) United States
(12) Patent Application Publication
(10) Pub. No.: US 2007/0014913 A1
(43) Pub. Date: Jan. 18, 2007

(54) Calcium fortified soymilk based frozen dessert

(75) Inventor: Jamie Lynn Miller, Pennsylvania, PA (US)

Correspondence Address: Minerals Technologies Inc., 1 Highland Avenue, Bethlehem, PA, 18017, US

(73) Assignee: Specialty Minerals (Michigan) Inc.

(21) Appl. No.: 11/180,102

(22) Filed: Jul. 13, 2005

(51) Int. Cl. A23L 1/20

(52) U.S. Cl. 426/634

(57) ABSTRACT

A soymilk based frozen dessert and process of making the soymilk based frozen dessert. The soymilk based frozen dessert is a calcium fortified soymilk based frozen dessert that uses calcium carbonate as the calcium fortifier.

The present invention pertains to calcium fortified soy based frozen dessert, which uses calcium carbonate as a calcium source and/or texturizing agent and the process for making the frozen dessert.

Dairy based frozen desserts (ice cream) have a complex colloidal structure of air, ice crystals, and fat crystals dispersed in an aqueous serum containing proteins and sugars. Protein functions as a stabilizer to stabilize the air bubbles. The combination of protein stabilized air bubbles and fat crystals provide strength and structure to the ice cream. The way ice cream feels in the mouth (mouthfeel) when eaten is generally controlled by the fat in the ice cream, but dispersed ice crystals also play a role in the texture of the ice cream. Therefore, by controlling fat and ice crystal size, a creamier, smoother feel can be obtained. In addition to proteins being used for stabilization, other stabilizers, such as, hydrocolloids can be used to promote long term stability as well as contribute to the body, texture, flavor release and freeze-thaw stability of ice cream. Additionally, a combination of hydrocolloids can serve to control the rate and growth of ice crystals during manufacture and freeze-thaw cycling and also impart gel structure.

Soymilk does not contain natural fat as is found in dairy products, therefore when ice cream is produced from soymilk, the natural fat is not present to provide the strength, structure, and smooth feel in the mouth. Therefore, to replace the fat, other functional additives, such as, hydrocolloids, proteins and carbohydrates or vegetable fats are used to provide air cell strength and resistance to damage from repeated freezing and thawing. However, dependent upon the amount and type of additives used, the texture and eating quality (mouthfeel) will be affected.

Additionally, from a nutritional point of view, soymilk based frozen desserts typically have from about 0 percent to about 2 percent Recommended Daily Intake (RDI) of calcium whereas, dairy ice cream has from about 6 percent to about 8 percent RDI of calcium. Therefore, when using soymilk as the base ingredient, a calcium-containing compound is required to achieve the same nutritional values found in the dairy products.

### SUMMARY OF THE INVENTION

Provided is a soy based frozen dessert including water, soymilk, sweeteners (sugars and carbohydrates), stabilizers, calcium carbonate, salt, flavorings and flavor masking agents.

Also, provided is a process for producing soy based frozen dessert wherein soymilk is admixed with water and agitated for a specified amount of time. Salt, sugars, and stabilizers can be added followed by carbohydrates, texturizing agents, flavorings, and flavor masking agents, to form a blend and mixing the blend for a specified amount of time. The blend is pasteurized, homogenized, and finally cooled. The ingredients can be added in any combination. For example, salt, sugars, carbohydrates, texturizing agents, flavorings, and flavor masking agents can be added to the soymilk in any order.

Also provided for is a powdered form of the above formulation wherein all the ingredients are packaged under dry conditions. The ingredients are then reconstituted and/or further processed at a later date to produce the desired frozen dessert.

The foregoing and other aspects will become apparent from the following detailed description of the invention when considered in conjunction with the accompanying Examples.

### BRIEF DESCRIPTION OF THE FIGURES

FIG. 1, illustrates a measure of the storage modulus (G′) of precipitated calcium carbonate (PCC) when used as an ingredient in a soymilk based frozen dessert.

### DETAILED DESCRIPTION OF THE INVENTION

According to the present invention, a calcium fortified soymilk based frozen dessert is provided. Additionally, the present invention provides a method for making the frozen dessert.

Provided is a frozen dessert with a taste, flavor, and texture like that of ice cream made from dairy products. The frozen dessert contains soymilk and calcium carbonate and may also contain stabilizers, emulsifiers, sweeteners, flavorings and flavor masking agents.

Soy forms the basis of the formulation for making the calcium fortified frozen dessert. As the starting material, soy can be prepared from soybean, non-fat soybean, concentrated soybean protein and separated soybean protein and the like. Additionally, soymilk powder can be used and soymilk such as commercially available soymilk incorporated with other raw materials such as hydrocolloids may also be used.

In addition to the soymilk, the formulation may contain water, sucrose, glucose syrups, hydrolyzed corn starch, rice syrups, stabilizers, calcium carbonate (ground or precipitated), salt and flavorings and flavor masking agents.

The frozen composition may contain water in an amount of from about 61 percent by weight to about 71 percent by weight of the total formulation, soymilk solids in an amount of from about 6 percent by weight to about 9 percent by weight of the total formulation, sucrose in an amount of from about 12 percent by weight to about 17.5 percent by weight of the total formulation, hydrolyzed corn starch with a D.E. value of 25 to 62 in an amount of from about 4 percent by weight to about 7 percent by weight of the total formulation, hydrolyzed corn starch with a D.E. value of from about 5 to about 20 in an amount of from about 2 percent by weight to about 4 percent by weight of the total formulation, stabilizer in an amount of from about 0.05 percent by weight to about 0.6 percent by weight of the total formulation, calcium carbonate in an amount of from about 2.5 percent by weight to about 5 percent by weight of the total formulation, salt in an amount of from about 0.1 percent by weight to about 0.2 percent by weight of the total formulation, flavoring in an amount of from about 0.2 percent by weight to about 0.8 percent by weight of the total formulation, and flavor masking agent in an amount of from about 0.1 percent by weight to about 0.4 percent by weight of the total formulation.

Additionally, the frozen composition may be made wherein the water is about 66.5 percent by weight of the total formulation, soymilk is about 8.0 percent by weight of the total formulation, sucrose is about 14.5 percent by weight of the total formulation, the corn syrup is about 5.0 percent by weight of the total formulation, the maltodextrin is about 3.0 percent by weight of the total formulation, the stabilizer is about 0.08 percent by weight of the total formulation, the calcium carbonate is about 2.8 percent by weight of the total formulation, salt is about 0.13 percent by weight of the total formulation, and flavoring and flavor masking agent is about 0.65 percent by weight of the total formulation. Additionally, more than one flavoring or flavor masking agent can be used. For example, the 0.65 percent flavoring and flavor masking agent in the above formulation can be 0.40 percent by weight flavoring and 0.25 percent by flavor masking agent.

Additionally, an emulsifier(s) may be used to contribute to a smoother texture and better shape retention. Emulsifiers that can be used include, but is not limited to, mono and diglyceride mixtures, polysorbates, and egg products.

The soymilk of the formulation may be reconstituted soymilk powder or an aqueous extraction from the bean, or a combination of the two such that the soymilk solids are about 8% by weight. This percent solids increases protein level for fat replacement and adds solids to the formulation. One such soymilk powder can be obtained from Devansoy Inc., 2211 6^{th} Ave, Grinnell, Iowa., 50112.

Sweeteners that are used are mainly sugars. Sucrose is commonly used as a sweetener in frozen desserts and can be any sucrose. This provides, in addition to sweetness, an enhancement of flavor, contributes to bulk or total solids, and affects freezing performance, body and texture of the final product.

Corn syrups are produced by starch slurry from corn wet milling processes subjected to a combination of heat, shear, and enzyme hydrolysis. Corn syrup a glucose syrup and can be any type of glucose syrup. An example of a corn syrup solids is Maltrin®M250 obtained from Grain Processing Corporation, 1600 Oregon St., Muscatine, Iowa, 52761. Corn syrup solids are used to contribute to the sweetness of the composition and add to the total solids and viscosity of the mix as well as helps control body and texture. The corn syrup solids also provide heat shock (the cyclical temperature conditions to which a frozen dessert is exposed during normal distribution) protection by water modification. An example of corn syrup would have a D.E. of about 20 or higher and a total solids content of about 70 percent or higher. The D.E. of 20 indicates the extent of hydrolysis or modification of the starch and is calculated using the formula:
(Molecular weight (MW) dextrose/Number average MW starch hydrolysate)×100

In addition to sucrose and glucose syrups, other sweeteners that may be used include, but is not limited to, lactose, dextrose, fructose, high fructose corn syrups (HFCS), sugar alcohols (i.e. sorbitol, mannitol, lactitol and xylitol), aspartame, saccharin, cyclamates, acesulfame-K, alitame, L-sugars and sucralose, may be used as sweeteners.

Maltodextrins are produced by terminating the conversion process below 20 D.E., using acid and enzyme processes. The maltodextrin, a carbohydrate, can be Maltrin®M040, from Grain Processing Corporation, 1600 Oregon St., Muscatine, Iowa, 52761. The maltodextrin is used to increase mouthfeel, body, and fat replacement as well as provides solids without adversely affecting the freezing point of the mix, i.e. inhibit crystallization of sucrose, dextrose and other sugars. Maltodextrins are also derived from corn starch, but the starch is much less modified than other corn sweeteners. Typical DE ranges for maltodextrins are from about 5 D.E. to about 20 D.E.

A stabilizer functions to stabilize the texture properties of frozen desserts at a point as close as possible to that of the freshly made product. In addition, to helping to stabilize the structure of the frozen dessert, they affect mix viscosity and homogeneity and during freezing, when gums are used, exert secondary effects on dryness and stiffness of the frozen dessert and in the finished frozen dessert controls the properties of the water that is unfrozen, therefore producing a smoother frozen dessert due to ice crystals taking longer to grow. Stabilizers can be any stabilizer as would be recognized by one of ordinary skill in the art and may be, but is not limited to, hydrocolloids, locust bean gum, guar gum, carrageenan, cellulose gum, microcrystalline cellulose, xanthan gum, alginates, pectin, gelatin, sodium carboxymethylcellulose, microcrystalline cellulose, methylcellulose and its derivatives. Many of these substances control the properties of the unfrozen water in the frozen dessert. Some of these substances can be obtained from TIC Gums, Inc., 4609 Richlynn Drive, Belcamp, Md., 21012. They can also be blends or mixtures of one or more gums such as TIC PRETESTED® Dairyblend IC Reg-AF, which can also be obtained through TIC Gums, Inc.

The calcium carbonate can be either ground or precipitated calcium carbonates (PCC). Precipitated calcium carbonates that can be used may be obtained from Specialty Minerals Inc., Bethlehem, Pa. 18017. Examples are ViCALity® Extra Light™ PCC, ViCALity® Heavy PCC, ViCALity® Albafil® PCC. Additionally, any calcium carbonate having an average particle size of less than about 4 microns and a surface area of greater than about 3 meters squared per gram may be used. However, the calcium carbonate can have an average particle size of about less than 2 microns and a surface area of greater than 9 meters squared per gram.

The calcium carbonate is used to increase the formulation solids, build structure and viscosity, as well as provides a calcium source resulting in a total calcium RDI of at least about 6 percent and may be at least about 80 percent. The calcium carbonate can be added to the mix as a dry ingredient without the need of high shear agitation, but needs to be added prior to homogenization.

Because the calcium carbonate has negligible aqueous solubility, they have an impact on the rheology and texture of the complex structure of frozen desserts. Using a small calcium carbonate particle, i.e. an average particle size of less than 2 microns, and a high surface area, i.e. greater than 9 meters squared per gram, helps it to interact with the other suspended particles, i.e. protein, fat, and stabilizer, and helps strengthen and increase the structure and build viscosity of the frozen product.

Salt used in the formulation can be sodium chloride or any other salt that is consumable by a human.

Flavorings can be added to the formulation in at least three different ways, directly to the mix prior to freezing, immediately post freezing or post freezing prior to packaging or can be added through a combination of all three. The Food and Agriculture Organization (AO) classifies flavorings in three categorizes as follows: Natural flavorings or flavoring substances, which include flavorings obtained exclusively by physical processes from vegetable, sometime animal raw materials intended for human consumption; Nature-identical flavoring substances, flavorings chemically isolated from aromatic raw materials or obtained synthetically being chemically identical to substances present in natural products intended for human consumption; and, Artificial flavoring substances. Flavorings not yet identified in a natural product intended for human consumption, either processed of not (e.g. ethyl vanillin). Flavorings are a concentrated preparation with or without solvent or carriers used to impart flavors. Any of these types of flavorings could be used in the formulation dependent upon a person's likes and dislikes. For example, Natural Blueberry Blackberry FL, #FAFJ424 from Wild Flavors Inc., 1261 Pacific Ave., Erlanger, Ky., 41016 is one such flavoring.

Flavor masking agents are generally used to offset the taste of other additives in the formulation. Flavor masking agents such as, but not limited to, Natural Sweet Resolver™ Type #FAFJ420, Wild Flavors Inc., 1261 Pacific Ave., Erlanger, Ky., 41016 and cyclodextrins and the like.

Total solids of most typical frozen dessert formulations are from about 29 percent to 33 percent for soft serve desserts and from about 37 percent to about 42.5 percent for hard frozen desserts. The total solids of the formulation presented herein can be adjusted to provide solids concentrations over the soft and hard frozen dessert range and can be about 33.5 percent.

The composition of the frozen dessert can be prepared by the following: If soymilk powder is used the powder is reconstituted with water using good agitation to form a soymilk suspension. Sucrose, salt and stabilizer are added to the suspension in no particular order, although they should be added under high shear so that the stabilizer is sufficiently hydrated. The other ingredients are added with good agitation forming a mix that is pasteurized for a specified period of time at from about 155 degrees Fahrenheit (68.3 degrees Celsius) to about 302 degrees Fahrenheit (150 degrees Celsius), homogenized at from about 500 to about 2500 pounds per square inch (psi) wherein pasteurization and homogenization can be done in either order. Additionally, homogenization can be done in multiple stages. The formulation is then cooled to from about 32 degrees Fahrenheit (0 degrees Celsius) to about 40 degrees Fahrenheit (4.4 degrees Celsius) and frozen. Optionally, the frozen dessert can be aged in a refrigerated vat. This is a process of quiescent storage of the mix with intermittent agitation for a period varying from 2.5 hours to 16 hours.

Additionally, soymilk, sweetener (sugars and carbohydrates), stabilizer, calcium carbonate, salt, flavoring and flavor masking agent can be combined in an essentially dry state wherein the ingredients are reconstituted and/or further processed at a later date to produce the desired frozen product.

Along with the calcium carbonate, ice crystals and the size of ice crystals affect the texture of the frozen product. Therefore, rheology can be used to quantify the texturizing property of precipitated calcium carbonate in the frozen product. The rheological measurement of storage modulus has been correlated to frozen dessert texture, namely ice cream, by Adapa, Dingeldein, Schmidt and Herald, “Rheological Properties of Ice Cream Mixes and Frozen Ice Creams Containing Fat and Fat Replacers,” J. Dairy Sci. 83:2224-2229, 2000. This reference is fully incorporated into the present application as a whole. Using this work, rheological testing of the calcium fortified frozen dessert formulation(s) was done.

### EXAMPLE 1

80 grams of soymilk powder was added to 665 grams of water in a Waring blender set on high agitation speed creating a suspension. Agitation was applied as the powder was added and for an additional 75 seconds after the powder was added. 1.3 gram of salt and 145 grams of cane sugar were added to the suspension followed by slowly adding 50 grams of 25 DE corn syrup solids. This mixture was agitated for 75 seconds after addition of the corn syrup solids was completed. To the mixture was added 30 grams of maltodextrin, 0.8 grams TIC PRETESTED® Dairyblend IC Reg-AF, 28 grams ViCALity® Extra Light™ PCC, 4.0 grams of blueberry blackberry flavoring, and 2.5 grams of natural sweet flavor masking agent creating a blend. The blend was heated to 95 degrees Celsius and cooled in a refrigerator for 3 to 5 hours prior to use.

### EXAMPLE 2

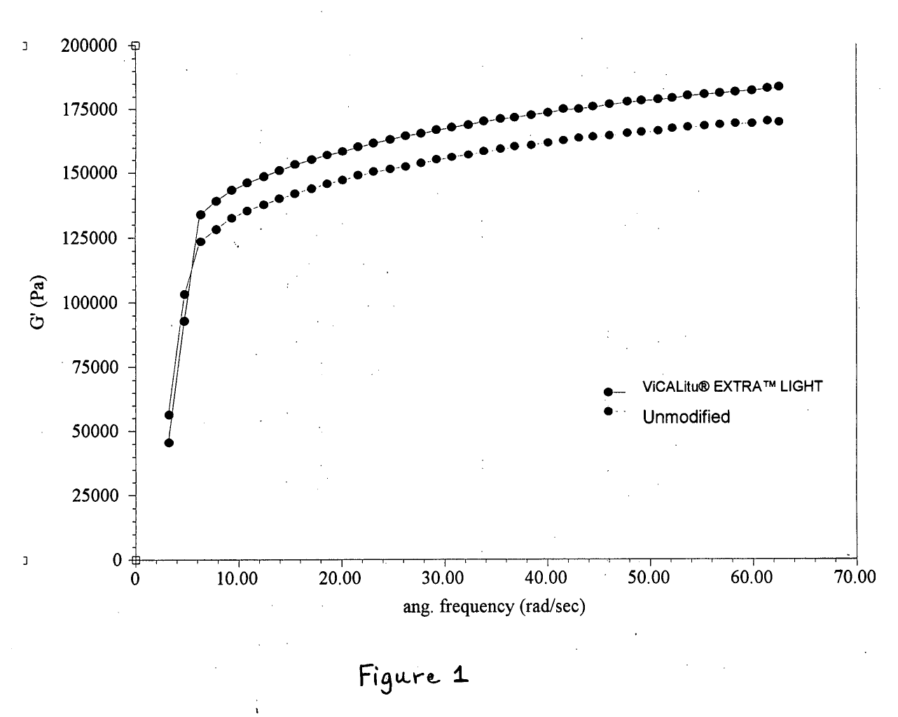

A rheological study was performed on soymilk soft-serve frozen dessert using ViCALity® Extra Light™ PCC of the formulation of Example 1. A TA Instruments AR 1000 Rheometer, 109 Lukens Drive, New Castle, Del. 19720, equipped with a 6 centimeter stainless steel parallel plate was used to determine rheological behavior. All testing was done in oscillation mode at minus 10 degrees Celsius. The geometries and samples were allowed to equilibrate to temperature before testing. A solvent trap was used to maintain temperature. The frequency sweep was performed at 0.5 Hertz (Hz), 0.25% strain, and a 450 micron gap. The results are shown in FIG. 1.

The ViCALity® Extra Light™ PCC enhanced the structure of the soymilk based frozen dessert as evidenced by the higher G′ values, which is a measure of the storage modulus.

### EXAMPLE 3

2,361 grams of soymilk powder was added to 19.4 kilograms of water in a jacketed steam kettle vessel. The soymilk and water were mixed for about 3 minutes. 38.4 grams of salt was admixed with 4,279 grams sugar and 23.6 grams stabilizer (TIC PRETESTED® Dairyblend IC Reg-AF) and added the admixture to the reconstituted soymilk and mixed for about 3 minutes. 1,476 grams corn syrup solids was added to this mixture and mixed for about 3 additional minutes. 826 grams of ViCALity® Extra Light™ PCC was admixed with 885 grams of maltodextrin and added this blend to the aforementioned mixture and mixed for about 5 minutes. This formulation was heated to about 145 degrees Fahrenheit in the jacketed steam kettle. Once the desired temperature was reached, 118 grams of flavoring and 74 grams of flavor masking agent were added to the formulation. A dye, FDNC blue #2 powder from Sensient®, 2526 Baldwin St., St. Louis, Mo. 63106, was added to the formulation to give coloring. The formulation was homogenized at 145 degrees Fahrenheit (low temperature long time) and 2,000 psi first stage and 500 psi second stage and pasteurized at 185 degrees Fahrenheit for 25 seconds with a Microthermics® HTST (high temperature short time) pasteurizing unit from Microthermics®, 3216-B Wellington Court, Raleigh, N.C. 27615.

Even though the invention is described above with reference to examples according to the accompanying specification, it is clear that the invention is not restricted thereto, but can be modified in several ways within the scope of the appended claims.

1. A soymilk based frozen dessert comprising:
water, soymilk, sweetener, stabilizer, calcium carbonate, salt, flavoring and flavor masking agent.

2. The soymilk based frozen dessert according to claim 1, wherein the soymilk is in powdered form.

3. The soymilk based frozen dessert of claim 1, wherein the sweetener is selected from the group consisting of sucrose, glucose, fructose, maltodextrin, lactose, dextrose, high fructose corn syrups (HFCS), sugar alcohols, aspartame, saccharin, cyclamates, acesulfame-K, alitame, L-sugars, sucralose and combinations thereof.

4. The soymilk based frozen dessert of claim 2, wherein the sugar alcohols are selected from the group consisting of sorbitol, mannitol, lactitol and xylitol.

5. The soymilk based frozen dessert of claim 1, wherein the stabilizer is selected from the group consisting of colloids, hydrocolloids, locust bean gum, guar gum, carrageenan, cellulose gum, microcrystalline cellulose, xanthan gum, alginates, pectin, gelatin, sodium carboxymethylcellulose, microcrystalline cellulose, methylcellulose and its derivatives and combinations thereof.

6. The soymilk based frozen dessert of claim 1, wherein the calcium carbonate is a ground calcium carbonate or a precipitated calcium carbonate or a combination thereof.

7. The soymilk based frozen dessert of claim 6, wherein the calcium carbonate has an average particle size of less than about 4 microns and a surface area of greater than about 3 meters squared per gram.

8. The soymilk based frozen dessert of claim 7, wherein the calcium carbonate has an average particle size of about less than 2 microns and a surface area of greater than 9 meters squared per gram.

9. The soymilk based frozen dessert of claim 1, wherein the salt is sodium chloride.

10. The soymilk based frozen dessert of claim 1, wherein the flavoring is from the group consisting of natural flavorings, nature-identical flavorings and artificial flavorings.

11. The soymilk based frozen dessert of claim 1, wherein the flavor masking agent is a cyclodextrins.

12. The soymilk based frozen dessert according to claim 1, wherein the water is in an amount of from about 61 percent by weight to about 71 percent by weight of the total formulation, soymilk solids is in an amount of from about 6 percent by weight to about 9 percent by weight of the total formulation, sucrose is in an amount of from about 12 percent by weight to about 17.5 percent by weight of the total formulation, a hydrolyzed corn starch with a D.E. value of 25 to 62 is in an amount of from about 4 percent by weight to about 7 percent by weight of the total formulation, a hydrolyzed corn starch with a D.E. value of from about 5 to about 20 is in an amount of from about 2 percent by weight to about 4 percent by weight of the total formulation, the stabilizer is in an amount of from about 0.05 percent by weight to about 0.6 percent by weight of the total formulation, the calcium carbonate is in an amount of from about 2.5 percent by weight to about 5 percent by weight of the total formulation, the salt is in an amount of from about 0.1 percent by weight to about 0.2 percent by weight of the total formulation, the flavoring is in an amount of from about 0.2 percent by weight to about 0.8 percent by weight of the total formulation, and the flavor masking agent is in an amount of from about 0.1 percent by weight to about 0.4 percent by weight of the total formulation.

13-21. (canceled)
